(19) United States
(12) Patent Application Publication
(10) Pub. No.: US 2012/0133357 A1
(43) Pub. Date: May 31, 2012

(54) HYBRID SENSOR ARRANGEMENT

(75) Inventors: Wolfgang Fritz, Giessen (DE); Klaus Rink, Rodenbach (DE)

(73) Assignee: Continental Teves AG & Co. oHG, Frankfurt (DE)

(21) Appl. No.: 12/992,348

(22) PCT Filed: Jun. 26, 2009
(86) PCT No.: PCT/EP09/58043

§ 371 Date: Dec. 6, 2010

(51) Int. Cl. G01B 7/14

(52) U.S. Cl. 324/207.24

(57) ABSTRACT

A position-sensor and/or speed-sensor arrangement comprising a sensor with at least a first sensitive main plane and an encoder with at least one encoder track face. The sensor senses a magnetic field generated and/or modulated by the encoder, and the sensor has at least a first magnetic field sensor element and a second magnetic field sensor element. The first magnetic field sensor element has at least a first main sensing direction and the second magnetic field sensor element has an at least second main sensing direction different from the first main sensing direction. The first magnetic field sensor element and the second magnetic field sensor element are arranged such that at least an element output signal of the first magnetic field sensor element has a phase shift absolute value between 75° and 105° with respect to at least one element output signal of the second magnetic field sensor element.

### CROSS REFERENCE TO RELATED APPLICATIONS

This application is the U.S. national phase application of PCT International Phase Application No. PCT/EP2009/058043, filed Jun. 26, 2009, the contents of such application being incorporated by reference herein.

### FIELD OF THE INVENTION

The invention relates to a position- and/or speed-sensor arrangement, a method for measuring positions and/or speeds, and to the use of the sensor arrangement in motor vehicles.

### BACKGROUND OF THE INVENTION

Document DE 10 2005 039 280 A1, which is incorporated herein by reference, proposes an integrated sensor which has a group of magnetic field sensor elements and a signal processing circuit. The group comprises in this context magnetic field sensor elements with different main sensing directions, for example both magnetoresistive sensor elements and Hall elements. The magnetic field sensor elements of the group are arranged here in the form of a grid and sense a magnetic field with spatial resolution, that is to say with respect to various sensing points.

### SUMMARY OF THE INVENTION

An object of the invention is to propose a position- and/or speed-sensor arrangement and a method for measuring positions and/or speeds which merely require relative simple signal processing in order to obtain position information and/or speed information and in particular additional information.

An object is achieved according to aspects of the invention by means of the sensor arrangement and the methods disclosed herein.

The invention is based on the concept of arranging at least two magnetic field sensor elements with main sensing directions which are different from one another in such a way that the element output signals of these magnetic field sensor elements have a phase shift absolute value between 75° and 105° in relation to one another.

A first sensitive main plane is preferably understood to be a plane with respect to which the sensor is sensitive and can sense field components of the magnetic field which penetrate this plane. The penetration angles of the field components which may be sensed are dependent herein in particular on the type and arrangement of the magnetic field sensor elements.

The encoder track face preferably has a scale for encoding or sensing rotational or alternatively translatory relative movements.

The magnetic field is preferably modulated by the encoder in the course of a relative movement between the encoder and sensor. In this context, the sensor or the encoder is arranged in a positionally fixed fashion.

The sensor arrangement is preferably connected to an electronic control unit via at least two lines and is supplied with energy via these two lines. The sensor is accordingly embodied as an active sensor.

The first main sensing direction of the first magnetic field sensor element is preferably located in the first sensitive main plane of the sensor.

The first sensitive main plane of the sensor is preferably a base face of a sensor housing or is essentially parallel to this base face.

The phase shift absolute value between the at least one element output signal of the first magnetic field sensor element and the at least one element output signal of the second magnetic field sensor element is essentially 90°.

It is preferred that the first and second magnetic field sensor element be embodied in such a way that the first magnetic field sensor element essentially senses magnetic field components in a different direction from the second magnetic field sensor element. This results from the first and second main sensing directions which are assigned to the respective magnetic field sensor element type.

The sensor is preferably oriented, with respect to its first sensitive main plane, essentially parallel to the encoder track face of the encoder. Alternatively, the sensor and encoder are preferably arranged oriented in relation to one another in such a way that the angle between the first sensitive main plane of the sensor and the encoder track face is less than 15°. As a result of this arrangement, the sensor arrangement may be embodied so as to be relatively flat and space-saving and therefore relatively cost-effective.

The first and second magnetic sensor elements each preferably have one or more sensitive structures which are each arranged essentially in one structural plane, wherein the first and the second magnetic field sensor elements are arranged, with respect to their particular structural plane, essentially parallel to one another or in a common plane. Alternatively, the angle between the structural planes of the first and second magnetic field sensor elements is preferably less than 15°. A sensitive structure is preferably understood to be here a conductor segment of a magnetoresistive sensor element and/or a Hall cell or a segment of a Hall element.

The first main sensing direction may be rotated through essentially 90° with respect to the second main sensing direction.

The first magnetic field sensor element with the first main sensing direction is preferably embodied as a magnetoresistive sensor element, and the second magnetic field sensor element with the second main sensing direction is preferably embodied as a Hall element. The at least one magnetoresistive sensor element is embodied as an AMR (anisotropically magnetoresistive) sensor element or GMR (giant magnetoresistive) sensor element or as some other magnetoresistive sensor element.

The encoder track face of the encoder is preferably encoded in an alternating fashion and has a plurality of North/South pole pairs and/or tooth/gap pairs.

At least the first magnetic field sensor element and the second magnetic field sensor element may be arranged in such a way that they essentially jointly sense the magnetic field with respect to the first sensitive main plane of the sensor at a defined common sensing point. In this context, one magnetic field sensor element or a plurality of magnetic field sensor elements are arranged with the first main sensing direction together in relation to one magnetic field sensor element or a plurality of magnetic field sensor elements with the second main sensing direction essentially concentrically with respect to the sensitive main plane and the defined sensing point. The common sensing point is preferably understood to be a common reading point of the sensor.

The sensor preferably has a signal processing circuit which is configured in such a way that it generates, at least from the element output signals of the first magnetic field sensor element and of the second magnetic field sensor element, a digital sensor output signal which contains at least one of the following information items:

the relative position and/or absolute position between the encoder and sensor and/or the relative speed between the encoder and sensor and/or the relative direction of movement between the encoder and sensor and/or the magnetic field strength of the magnetic field which is sensed by the sensor and/or the distance between the encoder and the sensor and/or at least an information item relating to the plausibility of the sensor output signal.

The sensor may comprise a chip which has at least the first magnetic field sensor element and the second magnetic field sensor element as well as the signal processing circuit. The chip is particularly preferably embodied as an ASIC, and comprises preferably at least an integrated Hall element and a magnetoresistive sensor element, which is mounted, for example, on an external face of the chip on an additional insulating layer using thin film technology.

The first and second magnetic field sensor elements are alternatively preferably connected to one another directly or indirectly by means of a wire bond or flip chip.

It is preferred that the sensor has at least one magnetic means, in particular a permanent magnet. The latter is particularly preferably magnetized in such a way that it makes available a magnetic assistance field for at least one magnetic field sensor element which is embodied as an anisotropically magnetoresistive sensor element, and/or generates a magnetic field which is modulated by an encoder, which essentially does not generate its own magnetic field, wherein the encoder for this is embodied at least partially from soft magnetic material.

The first magnetic field sensor element may be embodied as an AMR sensor element (anisotropically magnetoresistive), and the second magnetic field sensor element may be embodied as a Hall element. Owing to its relatively high measuring sensitivity, the AMR element is used to carry out relatively precise sensing of at least one scale division of the encoder and/or a defined scale division segment. Additional information is particularly preferably determined or calculated by means of the additional Hall element.

The method is preferably developed by virtue of the fact that at least one of the following information items is acquired directly or indirectly from the element output signals in a signal processing circuit:

the relative position and/or absolute position between the encoder and sensor and/or the relative speed between the encoder and sensor and/or the relative direction of movement between the encoder and sensor and/or the magnetic field strength of the magnetic field which is sensed by the sensor and/or the distance between the encoder and the sensor and/or at least one information item relating to the plausibility of the sensor output signal.

In this context the first magnetic field sensor element is embodied as a magnetoresistive sensor element, and the second magnetic field sensor element as a Hall element, and the two element output signals are generated in such a way that they have a phase shift absolute value of essentially 90° with respect to one another.

It is preferred that information about the relative direction of movement between the encoder and sensor be determined by virtue of the fact that the positive gradient, in particular the sign of the positive gradient, of the first element output signal is compared or taken into account with respect to the element output signals of the at least first and second magnetic field sensor elements in a first zero crossover with a positive gradient, in particular the sign of the positive gradient, of the second element output signal in a zero crossover which precedes or follows the first zero crossover. Alternatively, an information item relating to the relative direction of movement between the encoder and sensor is preferably determined by determining the sign of the value of an element output signal of another magnetic field sensor element during a zero crossover of an element output signal. In this case, the value of the element output signal of the other magnetic field sensor element is compared with an average voltage of the element output signals, in particular by means of a comparator. Alternatively, an information item relating to the relative direction of movement between the sensor and encoder is preferably determined by determining a relative change in position and/or a change in angle between the first element output signal and the second element output signal in that, in particular, the angle of the first element output signal with respect to a first time and the angle of the second element output signal with respect to a second time are determined and taken into account, wherein these first and second times are at a distance from one another which is smaller than half the period length of the element output signals. As a result, no zero crossover of one of the element output signals has to be taken into account in order to determine the relative direction of movement.

The magnetic field strength or information about the magnetic field strength of the magnetic field which is sensed by the sensor is preferably determined by virtue of the fact that, essentially at the time of a zero crossover of one element output signal, the value of the element output signal of another magnetic field sensor element is taken into account. At a zero crossover of the element output signal of a magnetoresistive sensor element the value of an element output signal of a Hall element may be taken into account, and the field strength and/or the magnetic flux density is preferably determined directly from this value. By means of the phase shift of the element output signals with respect to one another it is possible to use the zero crossovers of an element output signal essentially as an indicator for the presence of the maximum absolute value of the element output signal of the other magnetic field sensor element or as “trigger points” for determining the magnetic field strength. Preferably the distance or the air gap length between the encoder and sensor is subsequently determined from the at least one information item relating to the magnetic field strength and/or flux density. Alternatively, the magnetic field strength of the magnetic field which is sensed by the sensor is preferably calculated by determining the circle radius of the two element output signals which are embodied, in the form of sines and cosines, and preferably the root of the sum of the sine of the square of the value of the first element output signal and the cosine of the square of the value of the second element output signal is calculated, in each case at a defined time.

A zero crossover is understood to be undershooting or exceeding of a defined value, in particular of a mean value, by an element output signal.

The relative direction of movement between the encoder and sensor, the magnetic field strength of the magnetic field which is sensed by the sensor, the distance between the encoder and the sensor and the at least one information item relating to the plausibility of the sensor output signal are preferably additional information.

Position information and/or speed information is determined by interpolation in a signal processing circuit of the sensor and/or in an electronic control unit which is connected to the sensor. In this context, the element output signal of a Hall element is used for correcting and/or interpolating an element output signal of an AMR sensor element.

The magnetic field strength of the element output signal of a Hall element is preferably determined and taken into account in the evaluation of the element output signal of an AMR sensor element for the purpose of correction, with respect to the signal shape of the AMR element output signal, which preferably has harmonics as a function of the magnetic field strength.

In order to determine or calculate the relative position and/or speed between the sensor and encoder, an arc tangent function is preferably applied to the quotient of the values of the element output signals of the first and second magnetic field sensor elements, at a common time, wherein these element output signals are embodied as essentially sinusoidal or cosinusoidal signals which are phase-shifted with respect to one another through essentially 90°. This quotient to which the arc tangent function is applied in order to determine a position information item and/or speed information item is preferably stored for the respective value pairs of the element output signals of the first and second magnetic field sensor elements in a memory unit, preferably as a value table or as a “look-up table” which is determined experimentally and/or by simulation. This memory unit is accessed when the arc tangent function is applied. By storing values in a value table and using them in the application of the arc tangent function, it is possible to correct systematic errors, relating to the signal shape of the element output signals, relatively easily and precisely and to avoid errors resulting therefrom.

The element output signal of a Hall element is preferably used for “flip detection” of the element output signal of an AMR sensor element. “Flipping” is understood here to be signal interference which is expressed as undesired doubling of the signal frequency of the element output signal of the AMR sensor element and results, for example, from incorrect relative positioning between the sensor and the encoder.

The sensor comprises at least one AMR sensor element and is arranged in relation to the encoder in such a way that the AMR sensor element is operated in the weak field operating mode or as a field probe.

The magnetic field strength of the magnetic field which is measured and/or determined is also or alternatively understood to be the magnetic flux density or some other field variable.

The sensor arrangement may not be embodied as a material test probe, in particular not as a probe for sensing impurities in electrically conductive material or in electrically conductive samples.

The sensor is preferably embodied as a rotational speed sensor, in particular as a wheel speed sensor.

The sensor arrangement according to aspects of the invention and the method according to aspects of the invention are provided for use in all technical areas in which a rotational or translatory relative movement and/or a relative position between an encoder and a sensor are/is to be sensed. The sensor arrangement according to aspects of the invention and the method according to aspects of the invention are provided for use in motor vehicles or automation engineering. The use is provided in safety-critical applications, preferably in motor vehicle brake systems and/or control systems.

Further preferred embodiments emerge from the following descriptions of exemplary embodiments with reference to figures.

### BRIEF DESCRIPTION OF THE DRAWINGS

The invention is best understood from the following detailed description when read in connection with the accompanying drawings. Included in the drawings is the following figures:

FIG. 1 shows an exemplary embodiment of a sensor arrangement in which the sensor is arranged, with respect to its first sensitive main plane, parallel to the encoder track face of the encoder,

FIG. 2 shows an exemplary sensor arrangement in which the sensor is arranged, with respect to its first sensitive main plane, perpendicularly with respect to the encoder track face of the encoder,

FIG. 3 shows exemplary signal profiles of the element output signals of the first and second magnetic field sensor elements,

FIG. 4 shows exemplary embodiments of the relative arrangement of one or more magnetic field sensor elements with a first main sensing direction with respect to one or more magnetic field sensor elements with a second main sensing direction,

FIG. 5 shows an exemplary embodiment in which the sensor is connected to an electronic control unit, and

FIG. 6 shows an exemplary sensor which is embodied as an integrated chip.

### DETAILED DESCRIPTION OF THE PREFERRED EMBODIMENTS

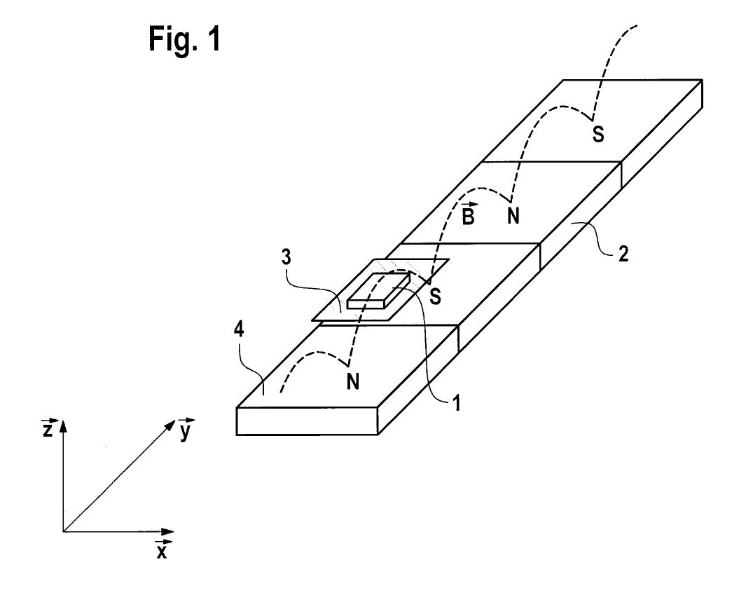

FIG. 1 illustrates an exemplary embodiment of a sensor arrangement in which the sensor 1 is arranged, with respect to its first sensitive main plane 3, parallel to the encoder track face 4 of the encoder 2. The encoder 2 is encoded in an alternating fashion and has north/south pole pairs N, S, between which the magnetic field \vec{B} is formed, only one field line being illustrated as a representation of the magnetic field \vec{R}. Sensor 1 comprises two magnetic field sensor elements (not illustrated), one of which is embodied as an AMR sensor element and has a first main sensing direction in the direction of the y axis of the illustrated Cartesian coordinate system or parallel to this y axis. The second magnetic field sensor element is embodied as a Hall element and has a second main sensing direction in the direction of the z axis or parallel thereto. These two magnetic field sensor elements sense the magnetic field which is generated by the encoder 2 and modulated in the course of relative movements between the encoder 2 and sensor 1 by the encoder 2, at a common sensing or reading point. As a result, by virtue of the “AMR” and “Hall” element technologies which are used for the magnetic field sensor elements, the element output signals of these two magnetic field sensor elements have a phase shift of 90° with respect to one another. The sensor 1 may have relatively compact dimensions here since the phase shift between the element output signals is not generated by a spaced-apart arrangement of the magnetic field sensor elements from one another in a relative direction of movement parallel to the y axis between the sensor 1 and encoder 2. The AMR sensor element is arranged with respect to its sensitive structures (not illustrated) in the sensitive main plane or arranged parallel to the encoder track face 4. The AMR sensor element is therefore operated in the weak field operating mode. This parallel orientation between the sensor 1 and encoder 2 produces a relatively flat and space-saving embodiment of the sensor arrangement.

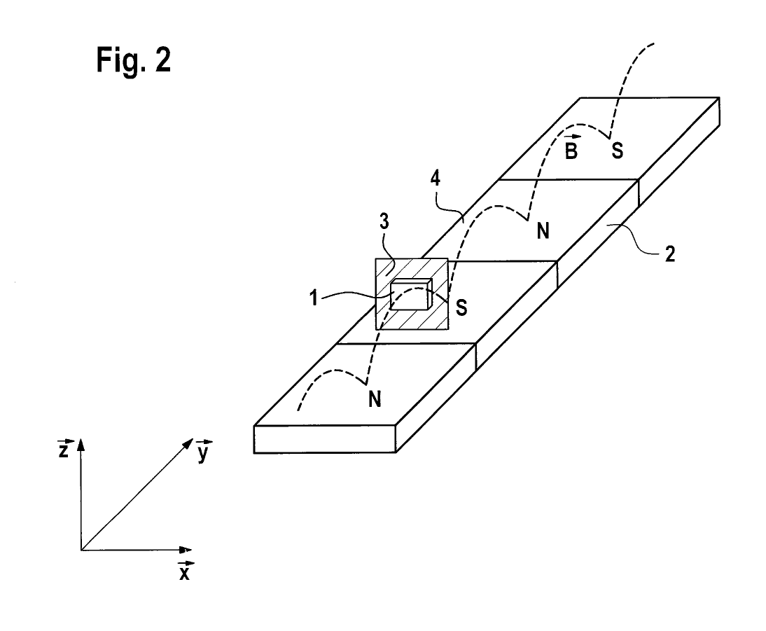

FIG. 2 shows an exemplary sensor arrangement in which sensor 1 is oriented, with respect to its first sensitive main plane 3, perpendicularly with respect to the encoder track face 4 of the encoder 2. A first magnetic field sensor element (not illustrated) which is embodied as an AMR sensor element and is arranged parallel to the sensitive main plane with respect to its sensitive structures, senses the magnetic field \vec{B}, for example, with respect to its components in the said direction. The second magnetic field sensor element (not illustrated) which is embodied as a Hall element and is also arranged parallel to the sensitive main plane 3 with respect to its sensitive structures and therefore parallel to the AMR sensor element, senses the y components of the magnetic field \vec{B}.

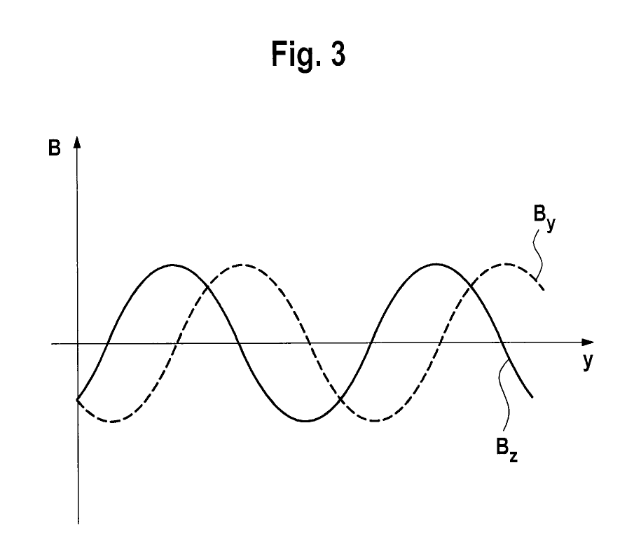

FIG. 3 illustrates exemplary element output signals of the magnetic field sensor elements of the sensor arrangement from FIG. 1. The sensed magnetic flux density B of the magnetic field components is illustrated by dashed lines in the y direction here.

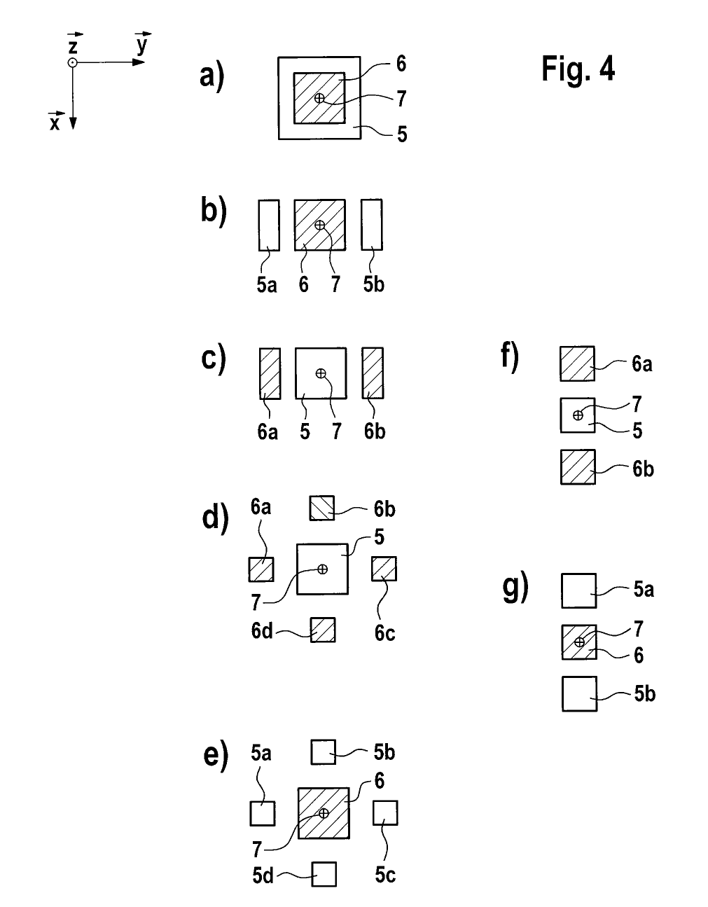

FIG. 4 shows, in the illustrations a) to g), various exemplary arrangements of the at least first magnetic field sensor element 5 or of a group of magnetic field sensor elements 5a, 5b, 5c, 5d with the first main sensing direction in relation to the second magnetic field sensor 6 or a group of magnetic field sensor elements 6a, 6b, 6c, 6d with the second main sensing direction. The magnetic field sensor elements with the first main sensing direction are embodied, for example, as AMR sensor elements, and the magnetic field sensor elements with the second main sensing direction are embodied as Hall elements, which are indicated by hatching. For example, all the magnetic field sensor elements are arranged, with respect to their sensitive structures, parallel or in the first sensitive main plane of the sensor or are located in a planar fashion with respect to the first sensitive main plane. The one or more AMR sensor elements 5, 5a, 5b, 5c, 5d are each arranged essentially concentrically here with respect to the one or more Hall elements 6, 6a, 6b, 6c, 6d and have a common defined sensing point 7. The AMR sensor elements 5, 5a, 5b, 5c, 5d have the first main sensing direction in the y direction, and the Hall elements 6, 6a, 6b, 6c, 6d have the second main sensing direction in the z direction, in each case according to the relative orientation between the sensor and encoder as illustrated in FIG. 1. With respect to a relative orientation between the sensor and encoder as illustrated in FIG. 2, the AMR sensor elements have the first main sensing direction in the z direction, and the Hall elements have the second main sensing direction in the y direction.

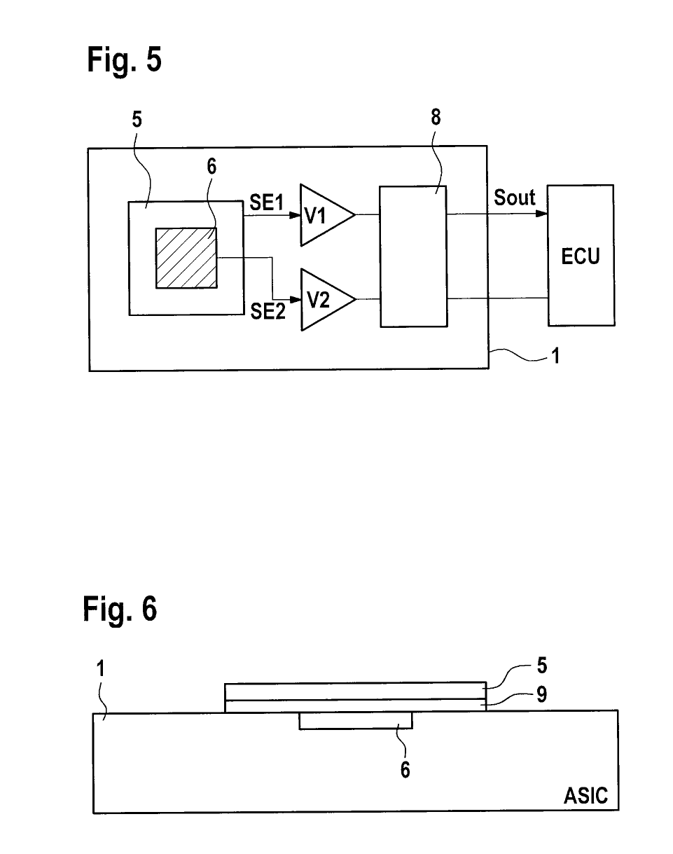

FIG. 5 illustrates, for example, the connection of a sensor 1 to an electronic control unit ECU by means of a two-wire interface. Sensor 1 has here an AMR sensor element 5 with the element output signal SE1, and a Hall element 6 with the element output signal SE2. The element output signals SE1, SE2 are each pre-amplified in a signal conditioning stage V1, V2 and fed to a signal processing circuit 8, which generates a digital sensor output signal Sout which is transmitted to the ECU. This sensor output signal contains, for example, position information, speed information and various additional information items.

FIG. 6 illustrates an exemplary integrated sensor 1 which is embodied as a chip. The sensor comprises an ASIC which has a signal processing circuit. A Hall element 6 is integrated, as a second magnetic field sensor element, into the ASIC. The ASIC has, on its upper outer face, an insulating layer 9 on which a magnetoresistive sensor element 5 is arranged as a first magnetic field sensor element, using thin film technology.

1.-14. (canceled)

15. A position- and/or speed-sensor apparatus comprising a sensor with at least a first sensitive main plane and an encoder with at least one encoder track face, wherein the sensor can sense a magnetic field which is generated and/or modulated by the encoder, and wherein the sensor has at least a first magnetic field sensor element and a second magnetic field sensor element, wherein the first magnetic field sensor element has at least a first main sensing direction and the second magnetic field sensor element has an at least second main sensing direction which is different from the first main sensing direction,
wherein the first magnetic field sensor element and the second magnetic field sensor element are arranged in such a way that at least an element output signal of the first magnetic field sensor element has a phase shift absolute value between 75° and 105° with respect to at least one element output signal of the second magnetic field sensor element.

16. The apparatus of claim 15, wherein this phase shift absolute value is 90°.

17. The apparatus of claim 15, wherein the sensor is oriented, with respect to its first sensitive main plane, essentially parallel to the encoder track face of the encoder.

18. The apparatus of claim 15, wherein the first magnetic field sensor element and the second magnetic field sensor element each have one or more sensitive structures which are each arranged essentially in a structural plane, wherein the first and second magnetic field sensor elements are arranged, with respect to their particular structural plane, essentially parallel to one another or in a common plane.

19. The apparatus of claim 15, wherein the first main sensing direction is embodied rotated 90° with respect to the second main sensing direction.

20. The apparatus of claim 15, wherein the first magnetic field sensor element with the first main sensing direction comprises a magnetoresistive sensor element, and the second magnetic field sensor element with the second main sensing direction comprises a Hall element.

21. The apparatus of claim 15, wherein at least the first magnetic field sensor element and the second magnetic field sensor element are arranged in such a way that they jointly sense the magnetic field with respect to the first sensitive main plane of the sensor at a defined common sensing point.

22. The apparatus of claim 21, wherein at least one magnetic field sensor element is arranged with the first main sensing direction together in relation to at least one magnetic field sensor element with the second main sensing direction concentrically with respect to the sensitive main plane and the defined sensing point.

23. The apparatus of claim 15, wherein the sensor has a signal processing circuit configured to generate, at least from the element output signals of the first magnetic field sensor element and of the second magnetic field sensor element, a digital sensor output signal (Sout) which contains at least one of the following information items:
a relative position and/or absolute position between the encoder and sensor,
a relative speed between the encoder and sensor,
a relative direction of movement between the encoder and sensor,
a magnetic field strength of the magnetic field which is sensed by the sensor,
a distance between the encoder and the sensor, and/or
at least an information item relating to the sensor output signal.

24. The apparatus of claim 15, wherein the sensor comprises a chip having at least a first magnetic field sensor element and a second magnetic field sensor element.

25. The apparatus of claim 24, wherein the chip further comprises a signal processing circuit (ASIC).

26. A method for measuring positions and/or speeds with a sensor apparatus as claimed in claim 15 wherein, by means of a sensor which has at least a first sensitive main plane and at least a first magnetic field sensor element and a second magnetic field sensor element, a magnetic field which is generated and/or modulated by means of an encoder is sensed, wherein the first magnetic field sensor element has at least a first main sensing direction and the second magnetic field sensor element has at least a second main sensing direction which is different from the first main sensing direction,
wherein at least one element output signal of the first magnetic field sensor element and at least one element output signal of the second magnetic field sensor element are generated in the course of the sensing of the magnetic field wherein these two element output signals have a phase shift absolute value between 75° and 105° in relation to one another.

27. The method of claim 26, wherein at least one of the following information items is acquired directly or indirectly from the element output signals in a signal processing circuit:
a relative position and/or absolute position between the encoder and sensor,
a relative speed between the encoder and sensor,
a relative direction of movement between the encoder and sensor,
a magnetic field strength of the magnetic field which is sensed by the sensor,
a distance between the encoder and the sensor, and/or
at least one information item relating to the plausibility of the sensor output signal.

28. The method of claim 26, wherein the first magnetic field sensor element comprises a magnetoresistive sensor element, and the second magnetic field sensor element comprises a Hall element, and the two element output signals have in particular a phase shift absolute value of 90° in relation to one another.

29. The use of the sensor apparatus of claim 15 in motor vehicles.

30. The use of the sensor apparatus of claim 15 as a rotational speed sensor apparatus.
